(19) United States
(12) Patent Application Publication
(10) Pub. No.: US 2010/0320228 A1
(43) Pub. Date: Dec. 23, 2010

(54) AUTOMATIC WATER GUN SYSTEM

(76) Inventor: JAMES CARROLL, BERKELEY SPRINGS, WV (US)

Correspondence Address: LAW OFFICE OF JERRY D. HAYNES , P.A, P.O. Box 350392, Fort Lauderdale, FL, 33335, US

(21) Appl. No.: 12/819,755

(22) Filed: Jun. 21, 2010

Related U.S. Application Data
(60) Provisional application No. 61/218,920, filed on Jun. 20, 2009.

(51) Int. Cl. F41B 9/00; B05B 9/043; B05B 9/08

(52) U.S. Cl. 222/79; 222/401

(57) ABSTRACT

The present invention relates to a water gun system comprising: a water reservoir, where the water reservoir includes pressurized air; a rechargeable battery, where the rechargeable battery supplies power to the pressurizing mechanism for the reservoir; an air intake valve, where the air intake that pulls air into the reservoir; a fill cap, where the fill cap for inserting water into the reservoir; and a water tube, where the water tube extends from the reservoir and includes a connector that attaches to a water gun. The reservoir further includes a power switch. An air pressure hose transmits pressurized into air within the reservoir. The water gun system may be assembled in a backpack form and includes at least one strap to enable a user to strap the backpack onto the user's back.

### CROSS REFERENCE TO OTHER APPLICATIONS

This application claims priority to U.S. Provisional Application Serial No. 61/218,920 filed on Jun. 20, 2009.

### BACKGROUND OF THE INVENTION

1. Field of Invention

The present invention relates to an automatic water gun and propulsion system.

2. Description of Related Art

A water gun is designed to shoot or propel water in a tight stream. The traditional water gun operates similar to a spray bottle and is usually a handheld toy shaped like a small handgun. The water gun may be made of hollow plastic that provides a container for the water and a trigger is provided that activates a pump, which squirts the water out of a nozzle.

Over time the technology related to water guns has advanced tremendously beyond the traditional trigger pump type of water gun. Other types of water gun include: a syringe/piston type gun where water is expelled from the gun through a syringe or piston like movement; air pressured guns include a water filled reservoir where a pump is used to push air into the water filled reservoir therefore increasing pressure thereon and the air essentially becomes compressed; an air separate pressure firing chamber type water gun works essentially on the same principal as a pressurized reservoir system, however instead of pressurizing the reservoir a separate fixed volume chamber is included on the water gun which water is pumped compressing the air inside; constant air pressure system water guns utilize fiber elastic chambers to power the water gun where the chambers may be symmetrical or spiracle in shape, constant pressure systems have an improved performance over other systems due to lack of firing angle limitations; rubber diaphragm/hydropower water guns utilize elastic rubber bladders to pressurize water; elastic/spring based water guns similar to the air pressure chamber systems utilize a separate air chamber that the water may be pressurized from the elastic nature of a rubber bladder and use metal springs in an order to provide energy behind a stream of water; and peristaltic pumps provide yet another system of water guns that are based upon rollers that pinch a soft piece of tubing and as rollers are rotated they squeeze water through the tubing pushing it in on the length that the rollers remain in contact with the tubing.

As the systems of water guns have developed over time various nozzles have been developed to create various spray patterns. The traditional nozzle includes a stream nozzle but other nozzles include a fan type, shower nozzle, blast nozzles, pulsating nozzles and rotating nozzles. Furthermore reservoirs have developed in order to utilize the technology related to water guns. The traditional reservoir is a full body reservoir that is found on the smaller trigger pump type water guns. Larger water guns, which utilize the pressure technique described above usually, include bottle type reservoirs with threaded fuel caps in order to seal the reservoir to create the required pressure associated with the water gun. In addition to reservoir bottles, backpack styled reservoirs may be utilized where the water is essentially strapped to the user's back and allows for increased capacity as opposed to the bottled reservoirs.

Some of the more advanced water guns utilize batteries and motors in order to pressurize the reservoirs sufficiently for operational purposes. Many water gun systems require manual pumping to create the required pressure. Although the water gun technology has advanced there remains further advancement and the automated techniques to enhance water gun systems.

### SUMMARY OF THE INVENTION

The present invention relates to a water gun system comprising: a water reservoir, where the water reservoir includes a means to pressurized the air within the reservoir; a rechargeable battery, where the rechargeable battery supplies power to the means to pressurize air with the reservoir; an air intake valve, where the air intake provides a means to pull air into the reservoir; a fill cap, where the fill cap provides a means to insert water into the reservoir; and a water tube, where the water tube extends from the reservoir and includes a connector that attaches to a water gun. The reservoir further includes a power switch. An air pressure hose transmits pressurized into air within the reservoir. The water gun system may be assembled in a backpack form and includes at least one strap to enable a user to strap the backpack onto the user's back. The backpack further includes cylinders that provide a means to pressurize the air within the reservoir and a motor where the motor turns pistons within the cylinders.

### BRIEF DESCRIPTION OF DRAWINGS

FIG. 1A depicts a backpack reservoir for the automated water gun system according to the present invention.

FIG. 1B depicts straps utilized with the backpack according to the present invention.

FIG. 1C depicts a side view of the backpack according to the present invention.

FIG. 2 depicts the internal components of the backpack according to the present invention.

FIG. 3A depicts an exemplary gun and internal tubing according to the present invention.

FIG. 3B depicts a second exemplary gun utilized with the present invention.

FIG. 3C depicts the internal components of the second gun utilized with the present invention.

FIG. 3D depicts a third exemplary gun utilized with the present invention.

FIG. 3E depicts the internal workings of the third gun utilized with the present invention.

FIG. 3F depicts a barrel assembly associated with the third gun utilized with the present invention.

FIG. 3G depicts a fourth exemplary gun utilized with the present invention.

FIG. 3H depicts the internal components of the fourth exemplary gun utilized with the present invention.

### DETAILED DESCRIPTION

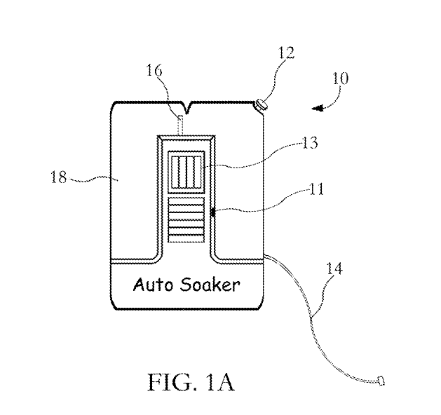

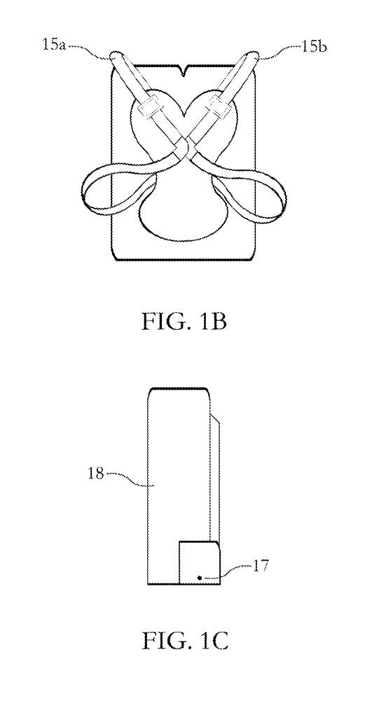

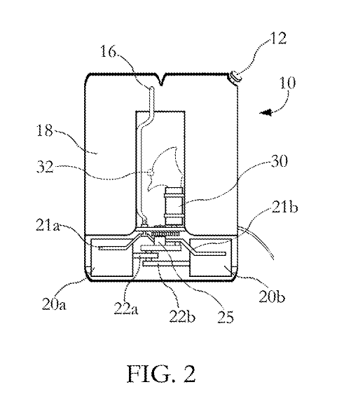

The present invention provides a new and improved automatic water gun system that includes a rechargeable battery powered pressurized water system. The automatic water gun system according to the present invention includes a backpack reservoir of water that delivers water through an attached water tube that connects to a variety of water guns designed for the water gun system. A backpack 10 according to the present invention is depicted in FIG. 1A. The backpack 10 includes a reservoir 18 that holds water for use with the water gun system according to the present invention. A water tube 14 extends from the reservoir 18 and provides a means for the connection of a powered water gun to the reservoir system. The backpack reservoir system 10 includes a power switch 11 and a rechargeable battery 13. The reservoir 18 includes an air-pressurized water system and an air pressure hose 16 transmits air into the reservoir 18 to pressurize the reservoir system for delivery of water through the water tube 14. Water may be filled into the reservoir 18 via a cap 12.

The backpack 10 may be worn on an individual's back via use of straps 15a, 15b as depicted in FIG. 1B. The straps 15a, 15b of the backpack reservoir 10 enable the user to carry a sufficient capacity of water to utilize through the water gun system. A side view of the backpack reservoir 10 is shown in FIG. 1C and includes an air intake valve 17.

FIG. 2 depicts some of the internal components of the backpack reservoir 10 according to the present invention. The backpack 10 includes cylinders 20a, 20b that provide a means to pressurize the air within the reservoir 18. A motor 30 turns pistons within the cylinders 20a, 20b. Air intake tubes 21a, 21b provide a means to receive intake air to pressure air within the reservoir 18. A pressure sensor 32 is provided to regulate the air pressure and to ensure adequate air pressure to operate the air system. The piston rods 22a, 22b connect to the crank 25 and therefore provides a means to pressurize the air system with the reservoir 18. The pressurized air within the reservoir therefore eliminates the necessity of any manual pumping that may be associated with some of the water gun systems of a prior art. The system is powered by a rechargeable battery 13 that supplies power to the motor 30. The rechargeable battery 13 is depicted in FIG. 1A.

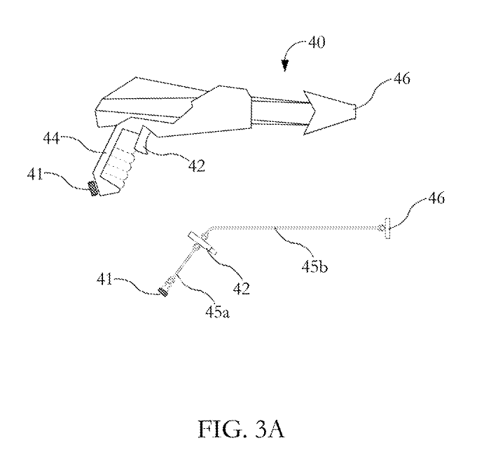

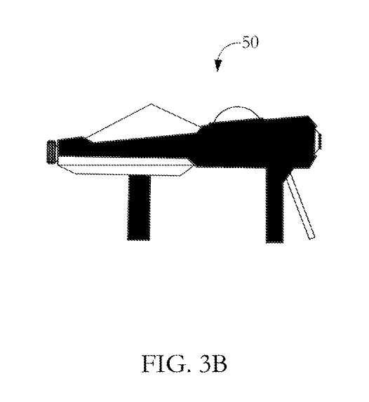

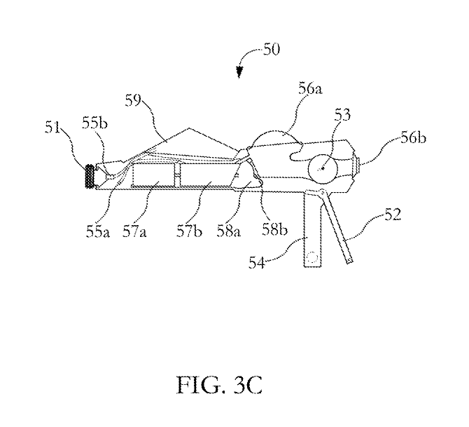

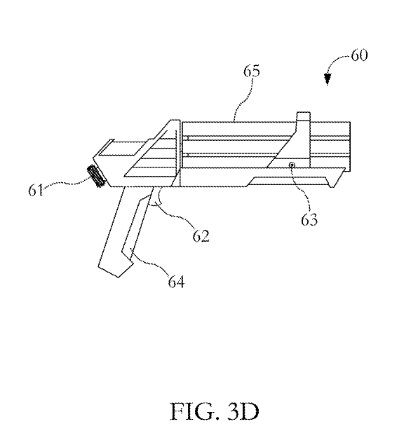

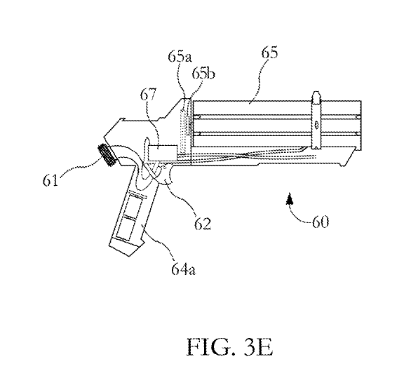

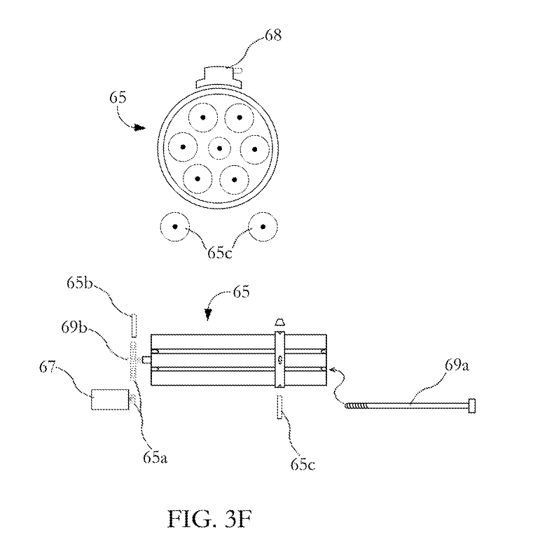

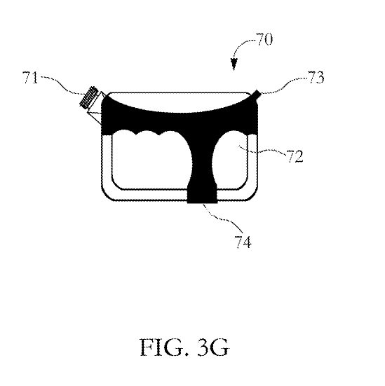

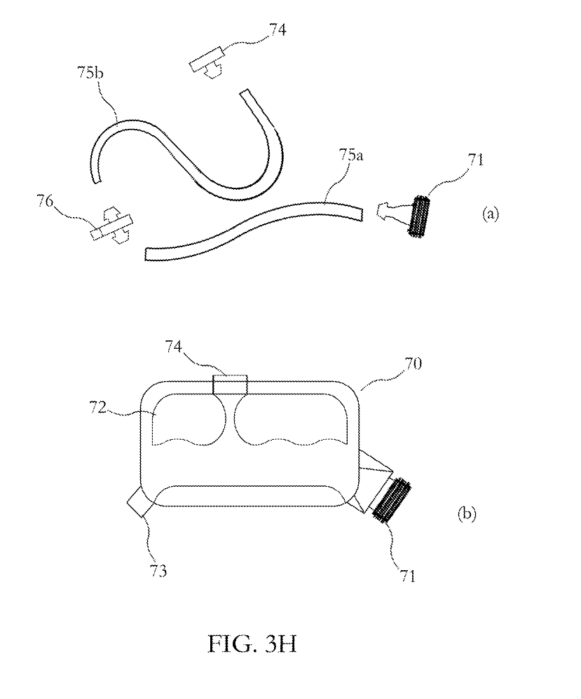

The water gun system according to the present invention in addition to providing a water reservoir 18 via backpack 10 also includes a variety of gun attachments that connect to water tube 14. The first such gun attachment is depicted in FIG. 3A. The water gun system according to the present invention includes a gun 40 which attaches to the water tube 14. The gun 40 includes a trigger 42, handle 44, an input connector 41 and an output nozzle 46. Also depicted in FIG. 3A is the internal tubing of the gun 40. The internal tubing 45a starts at the input connection 41 extends to the trigger 42 and continues to the output nozzle 46 via tubing 45b.

An alternative water gun for the present invention is depicted in FIG. 3B. An arm gun 50 is shown in FIGS. 3B and 3C. The arm gun 50 includes the inlet connection 51 and a squeezable hand trigger 52. A handle 54 extends downward from the arm gun 50 and may abut one side of the trigger 52. As contemplated by the present invention, the arm gun 50 may be strapped or attached to the arm of the user and therefore the trigger 52 is squeezed by the individual's hand against the handle 54 in order to release a stream of water through an outlet nozzle 56b. The arm gun 50 further includes a small water tank 56a that contains a portion of stored water within the arm gun 50. The water is supplied through the inlet 51 which connects to the water tube 14 of the backpack 10.

Other components of the arm gun 50 include an inner tubing 55b that transfers water from the inlet 51 into the small water tank 56a of the arm gun 50. A power switch 55a provides a means to activate power on the arm gun 50. Furthermore, an electrical motor 57a is also provided within the arm gun 50 with a screw pump 57b. Water is transferred through the inner tubing 55 through a pressure valve 58a and exits through the outlet nozzle 56b. A pressure sensor 58b is provided to regulate the water pressure the arm gun 50. A relief valve 53 is shown just inside of the outlet nozzle 56b. This relief valve 53 is activated via trigger 52 and releases the water for transmission through outlet nozzle 56b.

The arm gun 50 of the present invention provides a more high-powered and thicker stream of water out of the output nozzle 56b due to the electrical motor 57a and pump 57b provided within the arm gun 50. In addition to the pressure already provided via the reservoir 18, the water is further pressurized through the arm gun 50 by the screw pump 57b powered by the electrical motor 57a. The pump 57b increases the pressure of the water by about 100% or doubles the pressure once it is within the small water tank 56a. The electrical motor 57a is powered by a battery pack 59 within the arm gun 50.

A third style of water gun attachment is provided within the automated water gun system according to present invention and is depicted in FIGS. 3D, 3E, and 3F. A Gatling style gun 60 is shown in FIG. 3D. The Gatling style gun 60 includes an inlet connection 61 which connects to the water tube 14 of the backpack 10 and provides a means for the entry of water into the Gatling gun 60 system. The Gatling gun 60 further includes a trigger 62 and handle 64. The trigger 62 releases the water supply through the gun to enable the squirting of water through the barrels 65. A power button 63 provided on the outer portion of Gatling gun 16 activates the rotation of the barrels 65.

Some of the internal components of the Gatling gun 60 are depicted in FIG. 3E which includes a battery compartment 64a, barrels 65, barrel gears 65a, bearing assembly 65b and a motor 67. The distal ends of the barrels 65, about the last 2 inches thereof rotate similar to a traditional Gatling gun. As the barrels 65 rotate, a stream of water squirts from each individual barrel of the Gatling gun 60 once each barrel 65 reaches the top of the rotation. Tubing feeds to the side of each barrels of the Gatling gun 60 and provides a conduit for the water supplied to the gun 60. The output nozzles are depicted in FIG. 3F. Six barrels rotate through the Gatling gun 60 sequence and emit streams of water through each individual barrel. A water valve 68 is provided for supplying water to the top barrel as the barrels 65 rotate through sequence. The gears 65a and bearing assembly 65b rotate the barrels 65 of the Gatling gun 60 through the sequence of rotation and is powered by motor 67. Bearings 65c assist in holding the barrels 65 in place and inline as they rotate. A bolt 69a and nut 69b secures the barrels 65 and related components into the gun 60. The motor 67 is an electrical motor that receives power from the batteries contained in the battery compartment 64a. The pressurized water is received through the inlet connection 61 and emitted from the barrels 65 as desired by the user.

Another exemplary gun according to the present invention is depicted in FIG. 3G. A knuckle gun 70 is shown in FIG. 3G. A grip 72 is provided for the knuckle gun 70 with an output nozzle 74. Also an input connection 71 is provided for connection to the water tube 14 of the reservoir system 10. The knuckle gun 70 has also includes a thumb trigger 73 that provides a means to trigger the emission of water through the output nozzle 74. FIG. 3H (a) depicts some of the internal components of the knuckle gun 70, in particular tubing 75a, 75b extend through gun 70 and provide for water flow out of the output nozzle 74. A water valve 76 is shown between the two sections of tubing 75a, 75b.

As stated earlier the battery component of the reservoir system includes rechargeable batteries that may be recharged as desired. Further the batteries disclosed as associated with the guns used with the present water gun system are also rechargeable style batteries. The present water gun system provides a means to have an automated water gun with various water gun attachments thereto. The various water guns are utilized with the present system and may include further pressuring systems within the water guns themselves or utilize the pressurized water as transmitted through the water tube 14 of the backpack reservoir 10. Each of the guns that may be use with the present system includes input connections, which have similar threading to match a conventional garden hose. Such a connection enables the guns to be attached to a garden hose for water supply purposes. Any of the guns used within the water gun system according to the present invention provide a continuous stream of water as desired. The reservoir 18 also includes pressure sensors to regulate the pressure within the backpack 10. The water gun system according to the present invention provides various interchangeable water guns that create a unique experience in water gun usage.

What is claimed is:

1. A water gun system comprising:
a. a water reservoir, where the water reservoir includes a means to pressurized the air within the reservoir;
b. a rechargeable battery, where the rechargeable battery supplies power to the means to pressurize air with the reservoir;
c. an air intake valve, where the air intake provides a means to pull air into the reservoir;
d. a fill cap, where the fill cap provides a means to insert water into the reservoir; and
e. a water tube, where the water tube extends from the reservoir and includes a connector that attaches to a water gun.

2. The water gun system according to claim 1, where the reservoir further includes a power switch.

3. The water gun system according to claim 2, where an air pressure hose provides the means to pressurized the air within the reservoir.

4. The water gun system according to claim 2, where the water gun system is assembled in a backpack form and includes at least one strap to enable a user to strap the backpack onto the user's back.

5. The water gun system according to claim 4, where the backpack further includes cylinders that provide a means to pressurize the air within the reservoir and a motor where the motor turns pistons within the cylinders.

6. The water gun system according to claim 1, where said water gun includes a trigger, a handle, an input connector, an output nozzle and internal tubing, where the internal tubing extends from the input connector to the trigger and continues to the output nozzle.

7. The water gun system according to claim 1, where said water gun includes an inlet connection, a trigger and a handle, where the trigger is squeezed by the individual's hand against the handle to release a stream of water through an outlet nozzle, wherein the water gun further includes a water tank that contains a portion of stored water within the water gun, inner tubing transfers water from the inlet connection into the water tank, and an electrical motor is provided within gun with a screw pump.

8. The water gun system according to claim 7, where water transfers through the inner tubing through a pressure valve and exits through the outlet nozzle.

9. The water gun system according to claim 8, where a relief valve is just inside of the outlet nozzle, the relief valve is activated via the trigger and releases the water for transmission through outlet nozzle.

10. The water gun system according to claim 1 where the water gun includes a Gatling style gun, where said Gatling style gun includes an inlet connection which connects to the water tube of the backpack and provides a means for the entry of water into the Gatling gun.

11. The water gun system according to claim 10, where the Gatling gun further includes a trigger and a handle, where the trigger releases the water supply through the gun to enable the squirting of water through the plurality of barrels.

12. The water gun system according to claim 11, where a power button is provided on the outer portion of Gatling gun and activates the rotation of the barrels.

13. The water gun system according to claim 10, where the Gatling gun further includes a battery compartment, a plurality of barrels, a barrel bearing assembly and a motor, where the distal ends of the barrels rotate and a stream of water squirts from each individual barrel of the gun.

14. The water gun system according to claim 13, where tubing feeds to the side of each of barrels of the Gatling gun and provides a conduit for the water supplied to the gun, where the bearing assembly rotates the barrels of the Gatling gun 60 through the sequence of rotation and is powered by the motor, where the motor is an electrical motor that receives power from the batteries contained in the battery compartment.

15. The water gun system according to claim 1, where the water gun includes a knuckle gun where the knuckle gun includes a grip with an output nozzle, an input connection is provided for connection to the water tube of the reservoir and a thumb trigger, where said thumb trigger provides a means to trigger the emission of water through the output nozzle.
